(19) United States
(12) Patent Application Publication
(10) Pub. No.: US 2007/0244806 A1
(43) Pub. Date: Oct. 18, 2007

(54) Data processing method for the automatic provision of data and data processing device

(76) Inventor: Patrick Klingele, Gattikon (CH)

Correspondence Address: PAUL, HASTINGS, JANOFSKY & WALKER LLP, P.O. BOX 919092, SAN DIEGO, CA, 92191-9092, US

(21) Appl. No.: 11/651,052

(22) Filed: Jan. 9, 2007

Related U.S. Application Data
(60) Provisional application No. 60/759,615, filed on Jan. 18, 2006.

(30) Foreign Application Priority Data
Oct. 13, 2006 (EP) 06021497.0

(51) Int. Cl. G06Q 40/00

(52) U.S. Cl. 705/38

(57) ABSTRACT

An embodiment of the present invention provides a device and a data processing method for the automatic provision of data on computers at different locations, wherein the data are lending values and additional data attributes for marketable securities. An exemplary method includes automatically transferring market data of securities to a central computer system, determining a lending value for each of the securities for which market data were transferred, and transferring the determined lending values of the securities from the central computer system to the computers at the different locations. Determining the lending value of the each security can include referring to the market data transferred for the each security.

This application claims the benefit of U.S. Provisional Application No. 60/759,615, filed Jan. 18, 2006, and European Patent Application No. 06021497.0, filed Oct. 13, 2006, which are herein incorporated by reference in their entirety.

### BACKGROUND

1. Field of the Invention

The present invention relates generally to a data processing method for the automatic provision of data at different locations, and to a data processing device therefor.

2. Background of the Invention

It is well-known that banks or other financial service enterprises grant credits, wherein, for a credit of a major amount, a counter-value has to be offered to the credit grantor for safeguarding the credit. Especially with big banks, such a counter-value may, for instance, consist in securities, e.g., stocks, funds, bonds, conversion issues, noble metals, or other tradable valuables. To this end, the securities are stored in a deposit with the big bank, for instance, in a custody account, so that the big bank actually has access to the securities to be able to sell them, if necessary.

The value of the securities deposited for safeguarding a credit may, however, vary. Thus, the value of stocks or noble metals or other tradable securities may rise or fall. From experience, however, it is possible to assess the related risks for many types of securities.

For determining the amount of a maximum loan, the credit grantor therefore has to determine, taking into account the respective risk for each type of security to lend money for, up to which maximum amount it accepts the security for safeguarding the credit. The credit grantor thus determines a lending value for each security. The lending value thus corresponds to the value of a security which the credit grantor is able to realize with the calculated risk from the security in regular business in the future and in finite time. For a portfolio of securities deposited for safeguarding a credit, the maximum credit sum can thus be calculated by referring to the lending values.

The determination of a lending value for a security is, however, a problem to the extent that the future value of the securities is difficult to define for many types of securities. It is in particular securities such as stocks or hedge funds that may considerably gain or lose in value within a short time, so that they involve a high risk. For securities that have a high risk of loss in value, a low lending value will hence be fixed. Other securities such as bonds, the interest rates and thus the value changes of which are usually specified, have, as a rule, a distinctly lower risk. For those, a higher lending value may thus be determined.

The lending value for a security is typically determined by a person with sufficient experience in the assessment of the values of the securities. This person refers to various criteria for determining the lending values so as to be able to assess the risk of the future growth. Usually, this person refers only to criteria that can be derived definitely from the past and from the presence, and that will, with certain probability, also apply for the future.

Such a manual determination of a lending value has, however, a number of disadvantages. The analysis of the figures from the past involves substantial efforts, so that typically all the factors influencing the value cannot be taken into account. Due to the high number of different types of securities, very high effort is required to request the data of the past that are necessary for the determination for the individual case, and it is doubtful whether they can at all be procured in a sufficient amount for the past. For many securities, in particular fast moving ones, the subjective judgment of the respectively judging person will be authoritative to a great extent.

Another disadvantage of a manual determination results from the fact that banks, especially big banks, can have a number of subsidiaries in various countries of the world. It is, however, exactly in the interest of those big banks that such businesses with securities are treated as equally as possible, objectively, and in a calculable manner in the individual subsidiaries, so that they may act objectively and in a reliable manner toward the bank customers and offer them a deal that is attractive and transparent and comprehensible alike. Furthermore, it is in the natural interest of a credit grantor to be able to judge the deposited values for safeguarding a credit as objectively and realistically as possible so as to be able to objectively calculate the own risk related with the credit business, and to keep it low.

### BRIEF SUMMARY OF THE INVENTION

An embodiment of the present invention provides a device and a method for the automatic provision of consistent lending values of securities at different locations, which may serve as a basis for the determination of the totally resulting total lending value of a portfolio of a credit user, which corresponds to the maximum amount of a borrowing with reference to the portfolio for safeguarding of the credit. In one embodiment, the present invention provides a device and a data processing method for the automatic provision of lending value data on computers at different locations.

### BRIEF DESCRIPTION OF THE DRAWINGS

FIG. 1 is a simplified flowchart of the data processing method in accordance with an embodiment of the invention.

FIG. 2 is a flowchart of a simplified computer model for stocks and investment trusts.

FIG. 3 is a flowchart of a simplified computer model for bonds, conversion issues, and money market investments.

FIG. 4 is a schematic representation of a data processing device for performing the data processing method.

FIG. 5 is a view window for a first type of security (bond) in which the lending value calculated for a security as well as other data that are relevant for the calculation of the lending value of the security are displayed.

FIG. 6 is a view window for a further type of security (stock) in which the lending value for a further security as well as other data that are relevant for the calculation of the lending value of the security are displayed.

### DETAILED DESCRIPTION OF THE INVENTION

An embodiment of the invention provides a method involving the following steps:

A. Changing of control variables of computer models used for the determination of lending values, or of exclusion criteria used in the computer models, respectively, using corresponding control tables, if required and appropriate, before any of the following steps B to H is performed;

B. Automated transferring of market data from a market data server of a data supplier to the market data server of a central computer system, as well as processing and providing the market data (or correspondingly further processed or pre-processed (market) data) for step C, and storing all the data in the database of the market data server/the central computer system;

C. Automated transferring of master data and market data of securities from the valuables server or from the market data server, respectively, to a further server of the central computer system;

D. Performing a “Valmerge process” (cf. below);

E. Determining a lending value for each of the securities for which the master and market data were transferred by the further server, wherein, for the determination of the lending value of a security, a computer model stored for the respective type of security as well as the master and market data of this security transferred to the further server of the central computer system are referred to;

F. Keeping a history (storing) of the determined lending value and the pertinent master und market data of a security on a (further) database of the central computer system;

G. Displaying the determined lending value and the pertinent master and market data of a security in display windows that are designed individually in accordance with the type of security;

H. Transferring the determined lending values of the securities from the central computer system to the computers at the different locations, and transferring the determined lending values and additional data attributes to other computer systems.

In the first method step (step A), the variables of the computer models or of the exclusion criteria, respectively, are adapted in the correspondingly available control tables. This method is performed manually and is very advantageous since the operator of the central computer system, e.g., a big bank, is at any time capable of adapting the respectively used models and/or the “risk appetite” to modifications of the basic conditions of the market, modifications of the state of methodology, etc.

In the second method step (step B), the market data are fetched by an external market data server of a market data supplier—e.g., the company Bloomberg™—and loaded on a market data server of a central computer system (e.g., in an automated manner at respectively predetermined points of time, such as once a day). These data comprise—in the ideal case—for each marketable security, information such as the prices for which the security was traded at its trading centers, the daily trading volumes that were obtained for a security at its trading centers, and the price date (e.g., day and/or time of day). The trading centers may be stock exchanges or those trading centers at which relevant market data for a security are produced. Since these data are available in crude form, they can be further processed so as to be ready for the next process step (step C).

During processing, the crude data are, for instance, reassessed by influences on the price and/or the daily trading volume of a security caused by corporate actions events, e.g., stock splits. Data characterizing the respective corporate actions events may, for instance, also be reported by the above-mentioned market data server of the market data supplier to the market data server of the central computer system. This way, the market data server can automatically correct influences on the price (X₀) and/or the daily trading volume caused by corporate actions events (e.g. stock splits), so that the market data server, after a stock split of, for example, 1:2 (e.g., exchange of an old stock for two new stocks), recalculates all security prices that were historically supplied by the market data server of the market data supplier prior to the stock split (historic time series) from, for example, X (price at the day before the split) to a corrected or reassessed price X₋₁′=X₋₁/2, or from, for example, X₋₂ (price 2 days before the split) to a corrected or reassessed price X₋₁′=X₋₂/2 (or so that, e.g., with a stock split of 1:4 (e.g., exchange of one old stock for four new stocks) all security prices that were historically supplied by the market data server of the market data supplier prior to the stock split (historic time series) are recalculated from, for example, X₋₁ to a corrected or reassessed price X₋₁′=X₋₁/4, or from X₋₂ to a corrected or reassessed price X₋₂′=X₋₂/4). After this step has been concluded, different parameters are calculated for a respective security, such as the volatility of the price or of the price yields, the security, and the average daily trading volume thereof. In so doing, time series are formed with the prices and the daily trading volume of the security over a predetermined period of time or a predetermined duration, respectively, e.g., a predetermined number of trading days, and are referred to. The length of the time period taken into account for the calculation of the volatility and/or the average daily trading volume/the number of trading days taken into account (e.g., the last 30 days or the last 60 days) is variably adjustable, e.g., via corresponding control variables/control tables. All data—in crude form and processed or calculated (e.g., also the above-mentioned data concerning volatility and average daily trading volume)—are stored in the database of the market data server of the central computer system.

In the case of particular data supplied by the above-mentioned market data server of the market data supplier and characterizing, for example, corporate action events (e.g., data indicating an abandonment of the stock), the market data server of the central computer system may, for instance, set the above-mentioned value for the average daily trading volume for the respective security automatically to “0.”

Correspondingly similar, in the case of particular further data supplied by the above-mentioned market data server of the market data supplier and characterizing, for example, corporate action events (e.g., data indicating a declaration of bankruptcy of an enterprise), the market data server of the central computer system may, for instance, set the volatility value for the respective security automatically to “0.”

In a similar manner, for instance, if too few prices are available for a particular security for forming a volatility value having a correspondingly high exactness—e.g., if the number of prices available for the above-mentioned time period that has been taken into account underruns a predetermined, variably adjustable value—the market data server may also set the volatility value for the respective security automatically to “0.”

During the lending value determination for a security that is performed later by the above-mentioned further server, a volatility value of “0” assigned to a security, or a value of “0” assigned to a security for the average daily trading volume will always automatically result in a lending value of “0.”

In the third method step (step C), the master and market data of securities are, in an automated manner, loaded on the above-mentioned further server. The data transferred thus contain—in the ideal case—for each marketable security corresponding characteristics and basic data (prices), as well as the (market) data provided in accordance with method step B (e.g., the above-mentioned correspondingly further processed or pre-processed (market) data, and the above-mentioned data concerning volatility/average daily trading volume).

The transferring of the master and market data takes place in an automated manner and thus need not be triggered manually. The transfer of the data may, for instance, always be triggered at the same time of the day, for instance, by a so-called scheduler or cron process on the (further) server. On the (further) server, the market data are correspondingly stored for further processing.

In addition to the above-mentioned market data server, the further server may obtain, for individual ones of the above-mentioned securities and/or for further, additional securities, corresponding (further) master and market data and/or (further) data relating, for example, to the price, the main stock exchange center, the ratings of a security, from one or several additional computers, e.g. from an additional computer supplied with corresponding data by the company Telekurs™, and/or from a further, additional, bank-internal computer (e.g., from a computer of a foreign subsidiary of the big bank which is, for instance, able to supply price data relating to bonds, and rating data), and so on.

Advantageously, these data may be supplied by the respective source—e.g., Telekurs—in the respectively desired—further processed or pre-processed—form already, so that for these data, the performing of data further processing steps or pre-processing steps corresponding to step B may be omitted.

In the fourth method step (step D)—“Valmerge process”—the above-mentioned data that may originate from different sources (e.g., the above-mentioned market data server or the above-mentioned additional computers) are processed by the above-mentioned further server such that, for each security, one single data set is generated that is assigned to this security and that is stored in the corresponding database, said data set comprising, for instance, one single distinct volatility value assigned to the security, one single distinct value for the average daily trading volume assigned to the security, and distinct security price values.

The Valmerge process is only triggered when the further server has completely received the respectively corresponding data supply from all of the above-mentioned sources.

In the scope of the Valmerge process, it is first of all determined which of the data supplied by the different sources relate to respectively identical securities. Respectively identical securities may, depending on the source, be characterized by respectively different master data, e.g., in the case of a first source by the ISIN number, and in the case of a second source by the valuables number. For determining which of the data supplied by the different sources relate to respectively identical securities, the further server may, for instance, use one or several corresponding table(s) characterizing the allocation between different master data, e.g., an ISIN number—valuable number reference table.

If it is determined that competing data from different sources are available for one and the same security (e.g., competing price data and competing rating data), those data are respectively selected by means of corresponding prioritization methods that are to be used for the storing of the above-mentioned data set assigned to a respective security in the database.

Depending on, for example, the type of security, different prioritization methods may be used.

For instance, in the case of bonds, the data of the source can be prioritized and selected for storage in the above-mentioned data set that have the most recent price data, i.e., that are most up-to-date.

In the case of identical price data for different sources—e.g., the above-mentioned market data server (Bloomberg™) and the above-mentioned additional computer (Telekurs™)—the data of a particular source that has been predetermined in advance can be selected by way of default for the storage in the above-mentioned data set, e.g., the data of Bloomberg™.

For other kinds of data—e.g., rating data—a prioritization may, for instance, be performed only pursuant to the source. The further server may, for instance, preferably use the rating data of Bloomberg™ for storage in the above-mentioned data set. Only if no data of Bloomberg™ are available can rating data originating from a different source, e.g., rating data of Telekurs™, be referred to.

In the fifth method step (step E), a lending value is determined for each security for which master and market data could be transferred to the further server—on the basis of the data sets generated during the Valmerge process. In so doing, a computer model stored for the type of the respective security in the further server of the central computer system is referred to for each security, together with the market data transferred to the further server, for determining the lending value.

Thus, a lending value is determined for each security whose characteristics are stored in the further server of the central computer system and for which master and market data could be loaded on the further server.

In the sixth method step (step F), the determined lending values and the pertinent master and market data are stored for each security in the (further) database of the central computer system. In so doing, a history with the most current data and the data of the past is formed over a maximum predetermined period of time. All data that are older than this period of time (e.g., 2 years) are considered to be obsolete and are therefore deleted in the database.

In the seventh method step (step G), the determined lending values and the pertinent master and market data can—if required—be displayed for each security on a user interface (Global User Interface—GUI). Here, both the most current and the historicized data are displayed. The displayed data can comprise all the data that are relevant for the calculation of the lending value of a security. They are displayed in a view window that is, depending on the type of security (e.g., stocks, funds, bonds, conversion issues, or noble metals), designed individually or differently, so that only the information that matches the type of security is displayed.

Subsequently—in the eighth method step (step H)—the lending values of all securities are transferred from the central computer system (in particular from the above-mentioned further server) to the computers at the different locations (or, for instance, also to the above-mentioned computer of the foreign subsidiary of the big bank). The locations thus obtain the lending values of the securities based on the current market data. For the transfer of the lending values, an appropriate coding may be used. The respectively determined lending value is mapped on a code value assigned thereto (e.g., a lending value of 40% (i.e., a haircut of 60% (100%−lending value [%])), for example, to a code value “1060” (“1000”+haircut [%]). As used herein, haircut refers to the percentage deducted from the prevailing collateral market value.

In addition, the determined lending values and additional data attributes (e.g., data characterizing the market capitalization of enterprises and data characterizing the average daily trading volume of a security) may be transferred to one or several other computer systems. The computer systems may, for instance, be used for the quantification of risks for the big bank. With a first other computer system, for instance, customer portfolio simulations may be performed. Such simulations may include, for example, corresponding capital market stress situation (market shock) simulations, which simulate the effect of a market shock—such as the bankruptcy of a big enterprise or the insolvency of a threshold country—on the portfolio of a customer. Another exemplary simulation could involve corresponding customer bulk risk identification methods. Furthermore, corresponding parameters or risk factors may be calculated with a second other computer system, e.g., so-called expected loss data that may be used for the implementation of corresponding regulatory basic conditions, such as Basle II (e.g., for determining the corresponding Basle II-compliant regulatory capital for the big bank), or parameters or risk factors for the risk-adequate debiting of a customer income statement.

Before the above-mentioned market data can be transferred to the central computer system and can be processed there, for a clear identification of the securities, their characteristics have to be transferred in a master data set of the security to the computer system and have to be stored. In so doing, such a master data set is established for a security exactly when a lending value has to be determined for a corresponding security at a location of the big bank.

Advantageously, the method is performed on every day on which securities are traded and thus new market data are generated at the trading centers and are available. The determined lending values of the securities are thus always also based on the market data pursuant to the close of the market/close of the trading of the previous day or of the last trading day, respectively. For the big bank that is the credit grantor, this means increased safety since also the most recent data have been taken into account for a security when granting a credit.

The lending values determined for the individual securities and the pertinent master and market data may be stored permanently on the central computer system for each security (e.g., for a predetermined period, such as two years), so that they are available for every security with short access time. From the stored values, different parameters can be determined for the past, such as the volatility of a stock or the average daily trading volume thereof for a particular period of time. Statements for the future can be derived from such data with certain probability. The stored data may thus advantageously be taken into account during the determination of a current lending value.

The method may advantageously provide, in the case of those securities for which no lending value can be determined automatically, that a lending value is input manually. The input may take place after the performing of the method. If it turns out after conclusion of the method that, for instance, due to the lacking of market data a value could not be determined automatically, there is the possibility of inputting a value manually.

Furthermore, for some securities or types of securities for which a lending value cannot be determined via a computer model, there may be provided that a lending value always has to be input manually. Likewise there may be provided that an automatically determined lending value is overwritten by a manual input. This may, for instance, be beneficial if the available market data comprise an obvious error and thus a wrong or no lending value is determined.

Furthermore, there may also be provided that master and/or market data are input manually, and that input data attributes are automatically overwritten with the manually input data. This may, for instance, be beneficial if master and/or market data comprise an obvious error and thus a wrong or no lending value is determined.

The manual input of lending values as well as the manual overwriting of master and/or market data may advantageously be performed by performing a mass mutation on the central computer system or on the further server of the central computer system. This may particularly turn out to be very useful if a large amount of securities is concerned. In so doing, a file is read into the central computer system in a predetermined format.

The method may further provide that the market data can be transferred in collected form from an external market data server of a market data supplier to the market data server of the central computer system.

The method may also provide that the master data can be transferred in collected form from a master data server of the big bank to the server of the central computer system.

Furthermore, a data processing device is suggested for performing the method, wherein the device may comprise at least one central computer system with means for storing master and market data of securities, so that master and market data of securities can be stored for which a lending value is to be determined. The data processing device may be connected with at least one market data server and one master data server of the big bank. Furthermore, the data processing device comprises means for determining a lending value of a security, and is finally connected with at least one computer at a different location and possibly with one or several other computers or computer systems, respectively, for the transfer of the determined lending values.

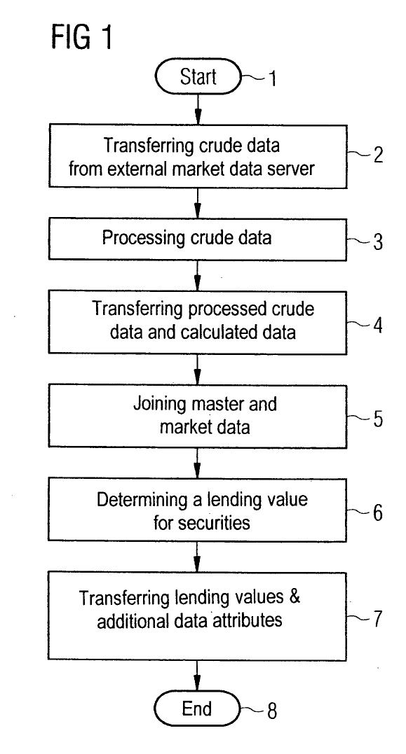

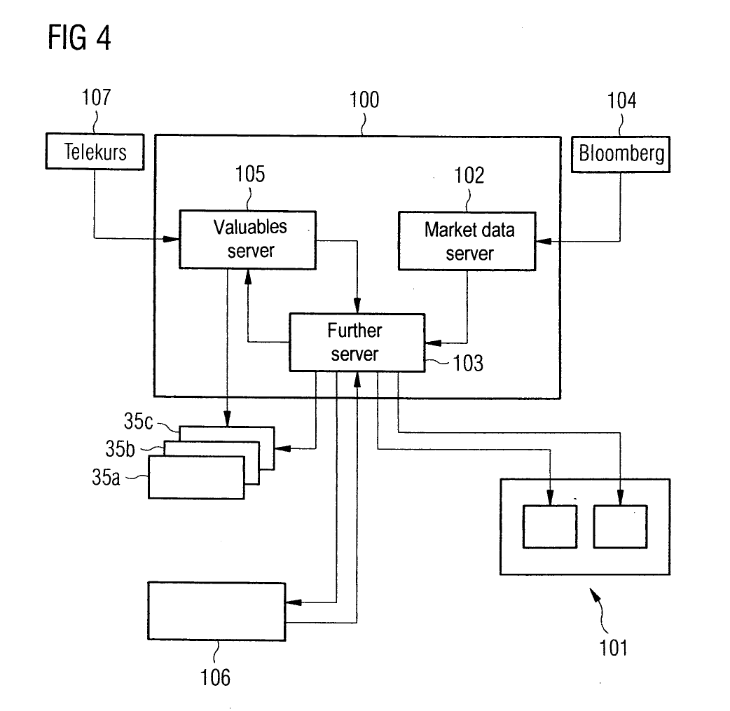

Turning to the figures, FIG. 1 shows a flowchart in which the individual steps of an exemplary data processing method are illustrated schematically in the way they are typically performed in a big bank, according to an embodiment of the present invention. The big bank can have subsidiaries all over the world which the lending values are to be reported to. The exemplary method provides lending values of securities in the headquarters and in all subsidiaries of the big bank (or, more exactly: in a central computer system 100 provided at the headquarters and in computers 35a, 35b, 35c provided at the subsidiary locations (cf. FIG. 4)). The exemplary method also supplies lending values as well as additional data attributes of securities to other computer systems of the big bank (cf., e.g., the other computer systems 101 illustrated in FIG. 4).

The other computer systems 101 may, for instance, be used for the quantification of risks for the big bank. For example, other computer systems 101 may perform customer portfolio simulations, may invoke corresponding customer bulk risk identification methods, or may employ corresponding risk factor calculation methods, for example, for determining expected loss data that may be used for the implementation of corresponding regulatory basic conditions, such as Basle II.

With continuing reference to FIGS. 1 and 4, step 1 designates the start of the data processing method. The method is typically performed on the central computer system 100, for example, by using a valuables server 105, a market data server 102, and a further server 103 (cf. FIG. 4 and the explanation below)—at the central seat of the big bank since, which typically possesses a sufficiently high-performance computer system and the appropriate personnel for operating and maintaining the system. The start 1 may be automated on the executing computer system in that the programs of the individual processing steps are started by a scheduler process that is adapted to start processes in a particular order, at particular times, and as a function of other processes. It is useful to start the processes that execute the individual process steps at points in time at which the market data are, according to agreement, available, so that the performing of the method may take place as quickly as possible and the determined lending values are available as quickly as possible.

On the start 1, the method acts on the assumption that master data of securities for which the subsequent data processing takes place have already been stored in a further server 103 of the central computer system 100, so that these may be accessed in the scope of the data processing. To that effect, the master data of the securities have to be input in the further server 103 of the central computer system 100 at least once prior to the first performance, so that they can be accessed when the further method steps are performed.

The inputting of the data in the further server 103 of the central computer system 100 is advantageously performed in a fully automated manner by means of a so-called batch run in which the master data of the securities are listed in ordered form in a file and are read by a program and input in the further server 103 of the central computer system 100. Since new securities frequently enter the market or stored master data may become obsolete if, for instance, the pertinent security no longer exists, the master data stored in the further server 103 of the central computer system 100 may also be updated at a later time.

The master data comprise, in addition to the characteristics of the securities, i.e., the International Securities Identification Number (ISIN) and/or the valuables number, for instance and inter alia the basic description, the name of the issuer of the security, the currency in which the security is traded or has been issued, respectively, and the domicile of the issuer, the coupon, and the date of expiration of the security in the case of a bond.

Furthermore, upon step 1, the method acts on the assumption that all the model variables of the computer models used for the calculation of lending values as well as corresponding exclusion criteria (cf. below) have been collected in corresponding control tables. The collecting (and possibly—later—the modifying) of the variables/exclusion criteria in the control tables is performed manually by an authorized person (i.e., a person having a “read and write” authorization for the system (and not just a “read” authorization). By the possibility of the subsequent modification of the model variables/exclusion criteria in the control tables, the system/the method can variably be adapted to changing circumstances, e.g., a changed risk appetite of the big bank.

In the second step 2 of the exemplary data processing method, market data of securities are fetched by an external market data server 104 of a market data supplier and loaded on the market data server 102 of the central computer system 100 (cf. FIG. 4). These are crude data (e.g., corresponding price data and rating data) that have to be further processed. Usually, market data are generated on each day on which securities are traded at trading centers, e.g., stock exchanges. After the closing of the trading centers, such as after close of the trading at the stock exchanges, they can be provided for fetching.

During the transfer of the market data (step 2), a file transfer may thus take place, from the external market data server 104 to the market data server 102 of the central computer system 100 of the big bank. The file transfer can be accomplished using transfer protocols such as file transfer protocol (“ftp”) or secure copy (“scp”), wherein the content is transferred in an encoded manner with the scp protocol.

For obtaining the market data, the big bank makes an agreement, for instance, with a data supplier, such as the company Bloomberg™, who has specialized on the collection of such market data, that the market data of a trading day are made available in a file with an agreed file format on an agreed server (here: the above-mentioned market data server of the market data supplier 104). On the market data server 102 of the central computer system 100, a process will then be triggered at the end of a trading day, which transfers this file with the crude data from the server (here: the above-mentioned market data server of the market data supplier 104) to the central computer system (here: the market data server 102 of the central computer system 100)—i.e., downstream. Alternatively, the server (here: the market data server of the market data supplier 104) might itself initiate a corresponding process and transfer the file—upstream—to the market data server 102 of the central computer system 100. The concluded file transfer then serves as a catalyst for the further processing.

In the third step 3 of the exemplary data processing method, market data are further processed by the market data server 102 of the central computer system 100 and are thus provided for the fourth step 4. During the processing, the crude data are, for instance, reassessed by influences on the price and/or the daily trading volume of a security caused by corporate actions events, e.g., stock splits.

After this first method has been concluded, different parameters are calculated for a respective security, for instance and inter alia, the volatility of the price or of the price yields, respectively, of the security, e.g., a stock and the average daily trading volume thereof. In so doing, time series are formed with the closing prices and the daily trading volume of the security, e.g., the stock, for a predetermined period of time and are referred to. All the data—in crude form and processed or calculated (e.g., also the above-mentioned data concerning volatility/average daily trading volume)—are stored in the database of the market data server 102 of the central computer system 100.

In the fourth step 4 of the exemplary data processing method, the above-mentioned security market data—i.e., the crude form data as well as the data processed/calculated by the market data server 102 of the central computer system 100 (e.g., also the above-mentioned data concerning volatility/average daily trading volume)—and corresponding master data are transferred from the market data server 102 of the central computer system 100 to a further server 103 of the central computer system 100 (cf. FIG. 4).

The master and market data comprise, in addition to the characteristics of the securities, i.e., the International Securities Identification Number (ISIN) and/or the valuables number, for instance and inter alia as price data the closing prices of the traded securities, the currency in which the security is traded, and further calculated values such as the volatility or the average daily trading volume for stocks, as well as, for instance and inter alia the closing prices, the currency in which the security was issued, the coupon, the domicile of the issuer, the expiration date and the ratings for bonds, and in addition the conversion premium for conversion issues.

The master and market data may be available in a file whose format is known on the central computer system 100 and can be processed there. Such a format may, for instance, provide that the data for a security are listed in a line. Such a line may in turn be subdivided into individual data fields comprising a fixed length or alternatively a variable length and a separator for separating the fields.

In addition to the above-mentioned market data server 102, the further server 103 may obtain, for individual ones of the above-mentioned securities and/or for further additional securities, corresponding (further) master and market data and/or further price data, such as the closing prices of the traded securities for stocks and the closing prices and the rating data for bonds. Further server 103 obtains this data from one or several additional computers, such as from an additional computer 105 of the central computer system supplied with corresponding data by the company Telekurs™ (or a computer 107 operated by the company Telekurs™) or from a further, additional, bank-internal computer 106 (e.g., from a computer of a foreign subsidiary of the big bank).

In the fifth step 5—“Valmerge process”—the above-mentioned data that may originate from different sources (e.g., the above-mentioned market data server and the above-mentioned additional computers) are processed by the above-mentioned further server 103 such that, for each security, one single data set is generated that is assigned to this security and that is stored in the corresponding database. The data set can comprise, for instance, one single distinct volatility value assigned to the security, one single distinct value for the average daily trading volume assigned to the security, and distinct security price values. The Valmerge process is only triggered automatically when the further server 103 has completely received the corresponding data supply (master and market data) from all of the above-mentioned sources.

In the scope of the Valmerge process, it is first of all determined which of the data supplied by the different sources relate to respectively identical securities. Respectively identical securities may, depending on the source, be characterized by respectively different master data, e.g., in the case of a first source by the ISIN number, and in the case of a second source by the valuables number. For determining which of the data supplied by the different sources relate to respectively identical securities, the further server may, for instance, use one or several corresponding table(s) characterizing the allocation between different master data, e.g., an ISIN number—valuable number reference table.

If it is determined that competing data from different sources are available for one and the same security (e.g., competing price data and competing rating data), those data are respectively selected by means of corresponding prioritization methods that are to be used for the storing of the above-mentioned data set assigned to a respective security in the database. Depending on, for example, the type of security, different prioritization methods can be used.

For instance, in the case of bonds, those data of the source can be prioritized and selected for storage in the above-mentioned data set that have the most recent price data, i.e., that are most up-to-date.

In the case of identical price data for different sources—e.g., the above-mentioned market data server (Bloomberg™) and the above-mentioned additional computer (Telekurs™)—the data of a particular source that has been predetermined in advance can be selected by way of default for the storage in the above-mentioned data set, e.g., the data of Bloomberg™.

For other kinds of data—e.g., rating data—a prioritization may, for instance, be performed only pursuant to the source. The further server 103 of the central computer 100 may, for instance, preferably use the rating data of Bloomberg™ for storage in the above-mentioned data set. Only if no data of Bloomberg™ are available can rating data originating from a different source, e.g., rating data of Telekurs™, be referred to.

The automatic determination of lending values for securities (step 6) starts as soon as the Valmerge process (step 5) has been concluded.

For some types of securities, calculating models are stored on the central computer system 100, and in particular the above-mentioned further server 103. In such a computer model, it is defined for one or several types of securities pursuant to which calculation rules and with which parameters a lending value has to be determined or to be calculated by the computer system.

For these types of securities, a lending value for a security can automatically be determined by means of the computer models for each day on which current market data are available.

The automatically determined values may subsequently be further processed immediately; there may, for instance, be examined whether limit values were exceeded or underrun. If a lending value for a security falls below a predetermined threshold value, it is placed in a queue for examination, so that the newly determined lending value can be validated by means of the available master and market data. This process of validation is performed by a sufficiently qualified person.

The method step of determining the individual lending value for a security is repeated for every security for which a computer model is stored and for which market data are available.

The data processing method also enables the manual input of lending values for securities for which, for instance, a lending value is not determined automatically by referring to a computer model, or for which the market data required for the automatic determination are not available for any reason.

Thus, for so-called structured products and hedge funds, lending values are determined manually, i.e., by a sufficiently experienced person, and input in the computer system (e.g., by a correspondingly authorized person, in particular a person possessing a “read and write” authorization for the computer system). For this purpose, a user interface (GUI) of the further server 103 of the central computer system 100 may be recalled or used, respectively.

After a lending value has been determined, it is stored along with the pertinent master and market data by assignment to the respective security. The thus originating history of a lending value of a security and of the master and market data thereof (i.e., the current as well as older, historicized, stored data) may then be accessed any time in that a correspondingly authorized person, e.g., persons having at least a “read” authorization for the computer system (e.g., all the employees of the big bank), can recall the history on the above-mentioned user interface (GUI) of the further server of the central computer system.

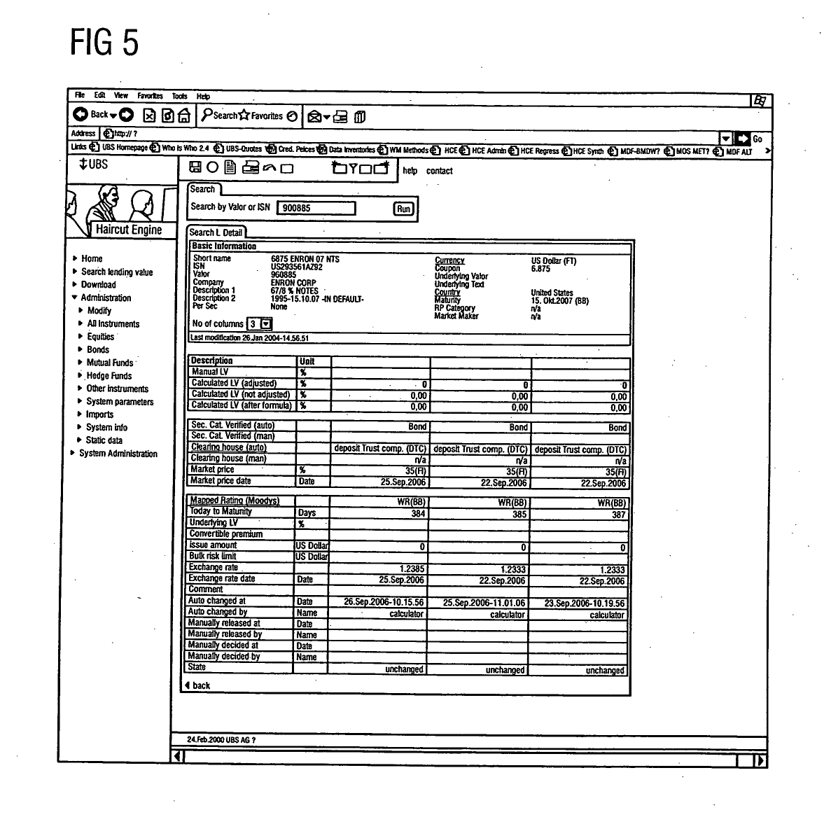

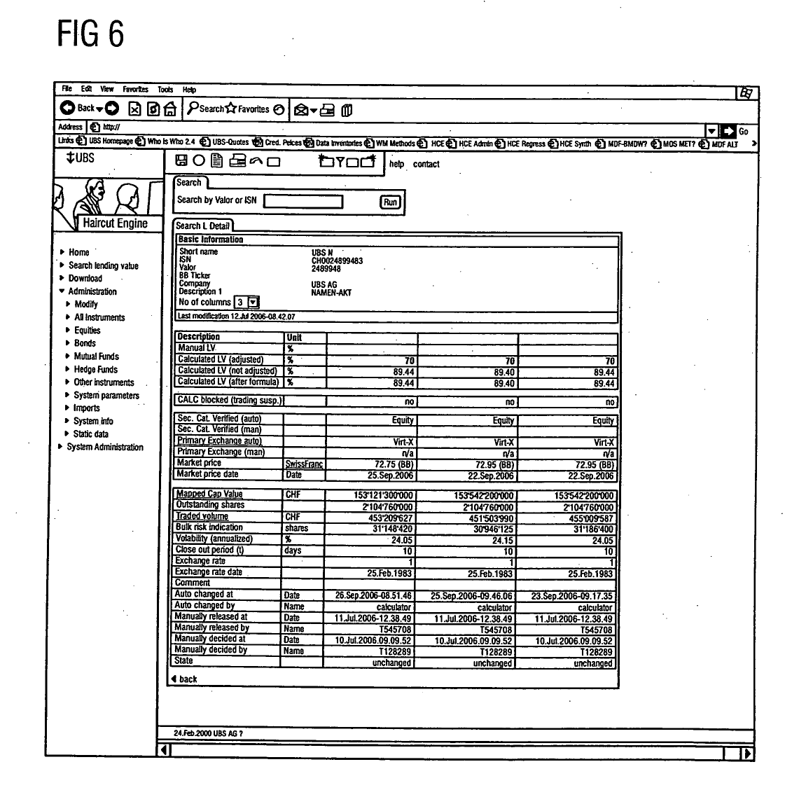

The displayed data comprise all the data relevant for the calculation of the lending value of a security. These data are displayed in a view window that is, depending on the type of security (e.g., stocks, funds, bonds, conversion issues, or noble metals) designed individually or differently, so that only the information that matches the type of security is displayed. Thus, not only a corresponding lending value can be recalled, but it may also be reconstructed on the basis of which master and market data the respective lending value was calculated. Examples of corresponding view windows are illustrated in FIG. 5 and FIG. 6 (wherein FIG. 5 illustrates a view window for security type “bond,” and FIG. 6 illustrates a view window for the security type “stock”).

In the last method step 7, the determined lending values are transferred to the different locations, or the determined lending values and additional data attributes are transferred to other computer systems 101 of the big bank, respectively. To this end, a file is preferably established in which the determined lending values are contained. The format of the file may be similar to the one described above. The file transfer may, for instance, be performed in accordance with an ASI method, with the file preferably being encoded due to the confidentiality of the information.

The transferring of the lending values to the different locations (or to computers 35a, 35b, 35c provided there), or the transferring of the lending values and of the additional data attributes to the other computer systems 101, respectively, may be performed in a fully automated manner, e.g., once a day. To this end, the lending values may be supplied from the above-mentioned further server 103 to a valuables server, e.g., the above-mentioned computer 105, and may be stored there, and then be transferred, by means of the above-mentioned method (e.g., the ASI method) from the valuables server 105 to the corresponding location computers 35a, 35b, 35c.

Alternatively or additionally—e.g., for a part of the locations or a part of the computers 35a, 35b, 35c provided there—a partially automated lending value transfer may also be performed, e.g., directly between the above-mentioned further server 103 and the corresponding location computers (without the interconnection of the above-mentioned valuables server 105). In so doing, the above-mentioned file—which comprises all the determined lending values, e.g., more than 100,000 lending values for more than 100,000 securities—or a corresponding file (or a copy thereof), is transferred, after a request triggered actively-manually at the side of a corresponding location computer, from the above-mentioned further server 103 to the corresponding location computer (“full download”). The access may be performed via a corresponding self-contained private network, e.g., a Virtual Private Network (VPN network) of the big bank, using the URL of the further server 103 of the central computer system 100 in the World Wide Web (WWW). The download performed this way must, however, be imported in the respective location computer by means of a corresponding upload. Alternatively or additionally—for a further part of the above-mentioned locations or a further part of the computers provided there—only a respective partial amount of the determined lending values may be accessed via the VPN network instead of all the determined lending values. Prior to the performance of a corresponding actively triggered download, a so-called shopping list will then be sent first of all from the respective location computer to the central computer system 100 or the further server 103, respectively, which comprises all securities for which the corresponding lending values are to be transferred. The number of securities contained in the list may be substantially smaller than the number of securities for which lending values were determined in the above-mentioned manner (e.g., typically between 1,000 and 50,000).

After the transfer of the lending values and of the further additional data attributes, the end 8 of the exemplary data processing method has typically been reached for a business day.

This way, current lending values are determined and transferred to the locations of the big bank on every business day. Likewise it may be examined whether limit values were exceeded or underrun. If a lending value for a security falls below a predefined limit value and/or if the totally resulting total lending value of a portfolio of a credit user falls below a predetermined limit value—which may be indicated correspondingly automatically by the computer system—the big bank may react correspondingly to the situation so as to reduce the credit risk. The bank may, for instance, request the credit user to deposit further securities for safeguarding the credit.

This way, the bank is able to examine by means of the current security market data whether the securities in the portfolio of a credit user are still sufficient for safeguarding the credit.

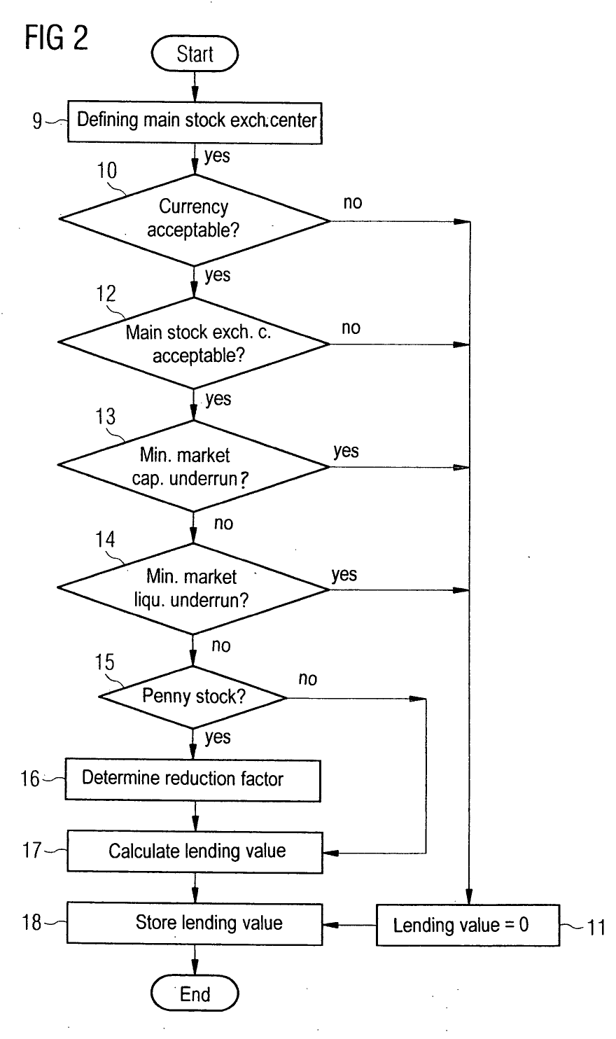

FIG. 2 shows by way of example a flowchart of a simplified computer model that is stored on the central computer system 100, in particular the above-mentioned further server 103, for the automatic determination of a lending value for stocks and investment trusts, according to an embodiment of the present invention.

For stocks and investment trusts, the further server 103 of the central computer system first of all defines, in the first step 9, the stock exchange center with the highest sales figures over a particular period of time (e.g., the last two months) as main stock exchange center, wherein the corresponding information may, for instance, be obtained from the above-mentioned valuables server 105. For the further considerations, exclusively the market data of this stock exchange center are taken into account.

Subsequently, in the following step 10, it is examined whether the security is traded in an acceptable currency. If a security is, for instance, not traded in an acceptable currency, which may be classified as non-acceptable for various reasons (exclusion criterion), the big bank will not advance money on this security. The security will correspondingly be assigned a lending value of 0 in step 111 if this exclusion criterion exists.

Furthermore, in the following step 12, it is examined whether the security is traded at an acceptable main stock exchange center. If a security is, for instance, not traded at an acceptable main stock exchange center, which may be classified as non-acceptable for various reasons (exclusion criterion), the big bank will not advance money on this security. The security will correspondingly also be assigned a lending value of 0 in step 11 if this exclusion criterion exists.

A further exclusion criterion for the advancing of money on a stock or an investment trust, respectively, is a minimum market capitalization of the corresponding enterprise. If a minimal value predefined for the market capitalization is underrun, the bank will not advance money on this security, either. In the following step 13, it will therefore be examined by means of the market price data and the number of securities existing, whether the predetermined minimum market capitalization has been underrun. If the minimum market capitalization has not been reached, a corresponding lending value of 0 will be assigned to the security in step 11.

Furthermore, in the following step 14, minimum market liquidity is referred to as a further exclusion criterion. If the average daily trading volume for the stock or the investment trust to be considered remains below a predetermined minimum value, the bank will not advance money on the stock or the investment trust, and the security will be assigned the lending value 0 in step 11.

In step 15, it will be examined whether the security belongs to the so-called “penny stocks,” i.e., whether the market price of the security lies below a minimum amount. Three values may, for instance, be predefined for this, which each effect that the lending value to be calculated is reduced correspondingly. If the market price lies below the first value, the lending value is reduced by a percentage rate (e.g., 25 percent). If it lies below the second value, the lending value is reduced by a higher percentage rate (e.g., 50 percent). If it lies below the third value, the lending value is reduced by 100 percent, which means a lending value of 0.

In steps 10, 12, 13, and 14, criteria are thus examined which may lead to an exclusion of the security from a loan (exclusion criteria).

The order of examination of these criteria is basically optional since the criteria are not dependent on each other. Correspondingly, the order of steps 10, 12, 13, and 14 may be exchanged optionally. Preferably, however, criteria that involve little effort are examined first, so that as little computing power as possible has to be spent to determine for a security whether it is lendable.

If a stock or an investment trust is, according to the aforementioned criteria, basically not excluded from a loan, the numeric lending value for the stock or the investment trust will be determined in the following step 17. To this end, that volatility value of the security is determined that can be achieved with a probability of 99 percent at the main stock exchange center within the ten trading days to follow (“99 percent confidence interval”).

The value of the volatility which can be achieved with a probability of 99 percent in regular trade within the sales period is extrapolated from the past to the future or a fictitious sales period of 10 days.

If a markdown value was determined for the security during the “penny stock” examination, the lending value will be reduced by this factor.

In the last step 18, the determined lending value will finally be stored in the above-mentioned database by assigning it to the respective security.

As has already been mentioned above, a respectively authorized person may adapt/modify the above-mentioned model variables and/or exclusion criteria and/or computer models via corresponding control tables. For example, instead of the above-mentioned exclusion criteria, correspondingly different or differently defined exclusion criteria may be used. In addition, instead of the above-mentioned variables, correspondingly different variables may be used. For example, instead of the above-mentioned 99 percent confidence interval, a correspondingly different confidence interval may be used. As another example, instead of the above-mentioned sales period of 10 days, a differently long sales period may be used. Other possible modifications include other acceptable currencies, other acceptable stock exchange centers, other minimum market capitalizations, other minimum daily trading volumes, other penny stock limits, and other penny stock lending value reduction factors.

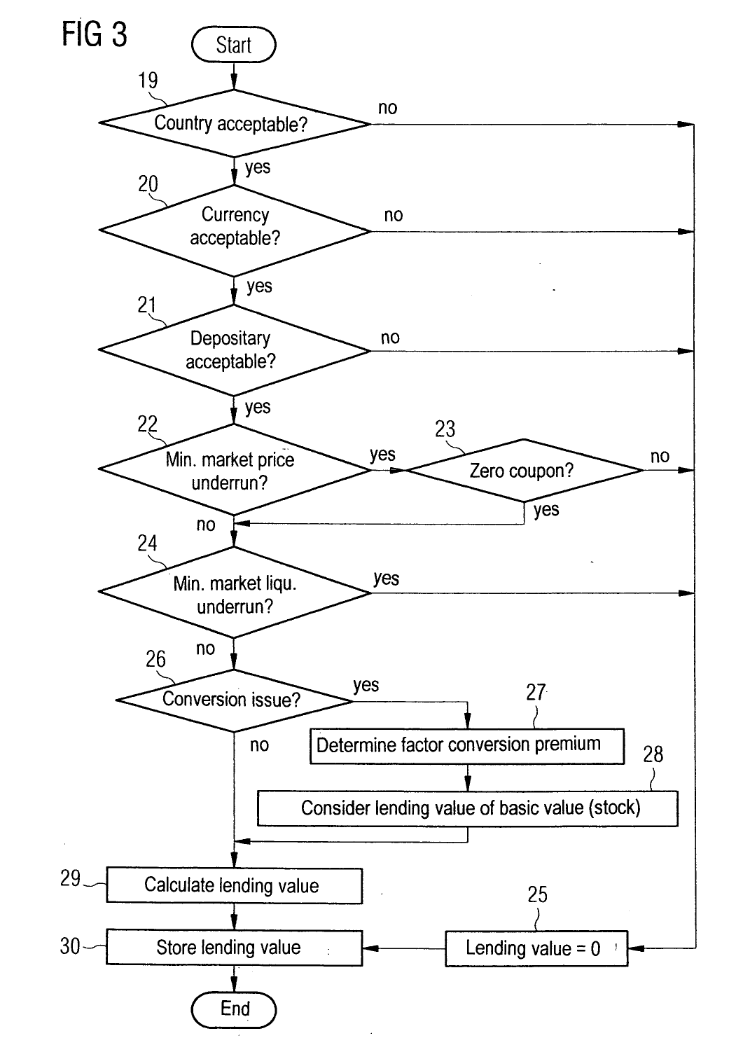

FIG. 3 shows a diagram of a computer model that is referred to for the automatic determination of lending values for bonds, money market investments, and conversion issues, according to an embodiment of the present invention.

Similar as with the computer model for stocks or investment trusts, first of all some exclusion criteria are examined for these types of securities. If at least one criterion has not been fulfilled, the bank will not advance money on the corresponding security. The lending value will correspondingly be set to 0.

In the first step 19, it is examined whether the issuer of the security has its headquarters in a country that is acceptable for the big bank.

Likewise, in steps 20 and 21, it is examined whether the security is based on a currency that is accepted by the big bank, and whether the depositary that administers the security is accepted.

If one of these exclusion criteria examined in steps 19, 20, 21 has not been fulfilled, the bank will not advance money on the security and the lending value will be set to 0, as in step 25.

Furthermore, the security to be examined here must not underrun a predetermined minimum market price (step 22). If this is the case, the bank will not advance money on the security and the lending value will be set to 0, as in step 25, unless the securities are bonds that have a zero coupon, which will be queried in step 23.

Furthermore, the security has to be traded with a minimum market liquidity, as in step 24. If this criterion is not fulfilled (exclusion criterion), the bank will not advance money on the security, either, and the lending value will be set to 0, as in step 25.

Like for the computer model for stocks and investment trusts, the order is optional during the examination of these exclusion criteria, but preferably such that less complex examinations are carried out first.

For conversion issues that can be converted to stocks, it is furthermore taken into account in step 27 whether they are “in money” or “outside money,” so that, for a conversion issue that can be converted to stocks, for which the probability of conversion has to be classified small, a higher lending value will have to be fixed due to the lower risk. Vice versa, for convertible conversion issues for which the probability of a conversion to stocks is high and which therefore have to be considered similar to a stock itself, a lower lending value is determined. In step 27, a factor that flows into the later numeric calculation and that is respectively different for the above-mentioned cases is correspondingly determined. In both cases, the amount of the lending value of the basic value, i.e., of the stock, will also be referred to for calculating the lending value of the conversion issue, as in step 28.

If, pursuant to these criteria, such a security is basically lendable, the volatility of the security is referred to in step 29 for the numeric determination of the lending value. It takes into account the yield curve sensitivity, the volatility of the credit spreads, and the probability of a downgrading of a rating, wherein only ratings of particular agencies, for instance, Standard & Poor's as well as Moody's, are taken into account. This volatility is—in analogy to the determination for stocks—calculated for a fictitious sales time of 10 days, which can be achieved with a probability of 99 percent in regular trade, i.e., that volatility value of the security is determined that can be achieved with a probability of 99 percent at the market within the ten trading days to follow (“99 percent confidence interval”). A market may be both a stock exchange center or a non-regulated trading center or so-called “Over-the-Counter” (OTC) market.

In the last step 30, the lending value for the security is stored.

A similar computer model is provided for the automatic calculation of lending values for investment funds.

Exclusion criteria that are examined in this computer model are whether the investment fund was issued in a country that is accepted by the big bank, whether the currency in which the investment fund issued is acceptable, whether a minimum fund size is not underrun, and whether a minimum market liquidity or redemption frequency, respectively, is not underrun.

The strategy underlying the fund will further be assessed. Thus, money market funds achieve a higher lending value than investment funds that are based on a stock strategy.

For the numeric calculation of the lending value, the value of the volatility from the past is here also extrapolated for a fictitious sales period of 10 days, wherein the volatility is adapted or multiplied, respectively, with a correction value alpha that ranges between a value of 1 and 4.29. The thus determined volatility corresponds to a probability of 99 percent that it can be achieved at the market within the ten trading days to follow. The market may be both a stock exchange center and the investment fund itself. The latter is, as a rule, obligated pursuant to the Investment Funds Act of its country of origin to take back its shares within the term stipulated in the sales prospectus and for the current net asset value, if such a redemption is desired by the investor.

Similar as explained above with respect to the computer model used for stocks and investment trusts, in the case of the computer models used for bonds, money market investments, and conversion issues or investment funds, a respectively authorized person may correspondingly adapt/modify the above-mentioned model variables and/or exclusion criteria, using corresponding control tables. For example, instead of the above-mentioned exclusion criteria, correspondingly different or differently defined exclusion criteria may be used. In addition, instead of the above-mentioned variables, correspondingly different variables may be used. For example, instead of the above-mentioned 99 percent confidence interval, a correspondingly different confidence interval may be used. As another example, instead of the above-mentioned sales period of 10 days, a differently long sales period may be used. Other possible modifications include other acceptable countries and other acceptable currencies.

A substantially simpler computer model is provided for the automatic determination of lending values for noble metals, for instance, gold, silver, platinum, and palladium, as well as for the deposit of money.

As exclusion criteria it is only examined here whether it is the matter of a noble metal that is acceptable to the big bank, or of an acceptable currency, respectively, and of an acceptable counterparty at which the money investment is placed.

For the calculation of a lending value on the merits, no market data are, however, taken into account, but the lending values are determined via fixed factors with respect to the individual amounts of the noble metals or of the deposits of money.

An automatic determination of a lending value is finally performed for Double Currency Units, so-called DOCUs, which are fixed term deposits in a basic currency that are paid back in a counter currency. These products have a fixed duration and focus on the exchange risk between two currencies.

As exclusion criteria, the currencies are examined, on the one hand, i.e., whether the respective currency is an acceptable currency. On the other hand, it is examined whether the remaining duration lies below a maximum value.

For the calculation of the lending value, the volatility of the exchange rate relationship between the two currencies is referred to, which is extrapolated for a fictitious sales period, wherein the remaining duration of the product is defined as sales period. The volatility determined corresponds to a probability of 99 percent that it can be achieved at the corresponding trading center within the sales period.

For other structurized products that are usually bound to stocks or an index, as well as for hedge funds, no computer model for the automatic determination of a lending value is stored in the central computer system. For these, it is instead determined manually whether these securities are lendable, and if so, with which lending value.

During the determination of lending values for these structurized products, the credit worthiness of the issuer and the underlying currency are inter alia taken into account. Furthermore, the underlying strategy, the quality of the basic value, and the liquidity and protection mechanisms are evaluated.

For hedge funds, the fund size, the cash frequency and thus the liquidity, and further characteristics are evaluated.

The lending value that has thus been determined manually for these products is then—also manually—input and stored for the security, and is thus, like the lending values that are automatically determined by reference to a computer model, also available for the further processing on the central computer system.

FIG. 4 shows a simplified diagram of an exemplary data processing device for performing the above-explained exemplary data processing method, according to an embodiment of the present invention.

As has already been explained above, the above-mentioned central computer system 100 of a big bank is used for performing the method. The central computer system 100 is adapted to be connected with the above-mentioned market data server 104 of the company Bloomberg™ and the above-mentioned Telekurs™ computer 107, and with the computers 35a, 35b, 35c provided at the subsidiary locations, and with the above-mentioned other computer systems 101—that are, for instance, used for the qualification of risks—and with a plurality of further computers, e.g., the above-mentioned computer 106 of a foreign subsidiary of the big bank.

The central computer system 100 comprises a plurality of suitable storage means for storing the computer programs in which the data processing method is mapped, and a plurality of central computer units, so-called central processing units CPU, for executing the computer programs, wherein the storage means and the CPUs may, for instance, each be provided on the above-mentioned market data server 102, the above-mentioned further server 103, and the above-mentioned valuables server 105.

The data processing method and the data processing device thus enable, based on current market data, the determination of lending values for securities which the subsidiaries of the big bank are interested in, in the headquarters of the big bank pursuant to defined computer models. The determined lending values are subsequently distributed to the subsidiaries, so that the lending values for securities are consistent and equal within the big bank.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM, etc.) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A data processing method for the automatic provision of data on computers at different locations, wherein the data are lending values for marketable securities, said method comprising:
transferring automatically market data of securities to a central computer system;
determining a lending value for each of the securities for which market data were transferred, wherein determining the lending value of the each security comprises referring to the market data transferred for the each security; and
transferring the determined lending values of the securities from the central computer system to the computers at the different locations.

2. The method of claim 1, further comprising:
transferring automatically market data or further market data and master data of the securities to a further server of the central computer system.

3. The method of claim 2, further comprising:
displaying in an individually designed view window a respectively determined lending value of a security and any pertinent market data, further market data, or master data of the security.

4. The method of claim 1, wherein transferring the determined lending values of the securities from the central computer system to the computers at the different locations is performed in a fully automated manner.

5. The method of claim 1, wherein transferring the determined lending values of the securities from the central computer system to the computers at the different locations comprises one of a full download method and a shopping list method.

6. The method of claim 1, wherein determining lending values of particular types of securities comprises automatically calculating the lending values using computer models stored for each respective type of security on the central computer system.

7. The method of claim 6, wherein at least one of a computer model and variables characterizing the computer model can be modified.

8. The method of claim 1, wherein the market data are transferred to the central computer system in the form of crude data, and wherein data calculated from the crude data are used for determining the lending values.

9. The method of claim 1, wherein the market data are transferred from a first source and a second different source, and wherein the method additionally comprises:
determining whether the market data transferred from the first source or the market data transferred from the second source are to be used for determining the lending value.

10. The method of claim 9, further comprising:
determining whether competing market data of different sources are available for a certain security; and
using a prioritization method for selecting the market data that are to be stored in a database or used for determining the lending value of the certain security.

11. The method of claim 1, wherein the method is performed on each day on which new market data are available.

12. The method of claim 2, wherein a determined lending value and its pertinent market data and master data are stored permanently on at least one of the central computer system and the further server of the central computer system.

13. The method of claim 1, further comprising receiving manually entered lending values for securities for which a lending value cannot be determined.

14. The method of claim 1, wherein at least one of the market data and the master data of a security comprise an obvious data error, and the method further comprises receiving manually entered data attributes of the security and overwriting the data error.

15. The method of claim 2, further comprising receiving one of manually input data of a security and manually input lending values, on the basis of a mass mutation on the further server of the central computer system.

16. The method of claim 6, wherein at least one exclusion criterion is provided in the computer model, on fulfillment of which a lending value is determined for a security which indicates that the security will not be lendable.

17. The method of claim 1, wherein determining the lending value of a security is based on the volatility of the market price which has been extrapolated for a fictitious period.

18. The method of claim 1, wherein the data provided on computers at different locations comprises lending values and additional data attributes for securities, and wherein the method additionally comprises transferring the additional data attributes to further computer systems.

19. A system for data processing comprising:
a server that stores characteristics of securities; and
a processor in communication with an external computer of a market data supplier and at least one computer at another location, the processor adapted to execute instructions
receiving market data of the securities from the external computer and storing the market data in the server, and
determining a lending value of a security based on the market data, and
transferring the determined lending value to the at least one computer at another location.

20. The system of claim 19, further comprising means for archiving the determined lending value.

21. The system of claim 19, wherein the market data are transferred in the form of crude data, and wherein the system comprises means for further processing the crude data to further processed data, wherein the lending value is determined on the basis of the further processed data.

22. A computer program adapted to be executed by a processor to perform a data processing method for the automatic provision of data on computers at different locations, wherein the data are lending values for marketable securities, said method comprising:
transferring automatically market data of securities to a central computer system;
determining a lending value for each of the securities for which market data were transferred, wherein determining the lending value of the each security comprises referring to the market data transferred for the each security to the central computer system; and
transferring the determined lending values of the securities from the central computer system to the computers at the different locations.

23. The computer program of claim 22, wherein the computer program is stored on a computer-readable storage medium.

24. A method for automatically disseminating lending values of marketable securities from a central bank to a plurality of subsidiaries, the method comprising:
storing master data of the securities in a central computer system of the central bank;
receiving automatically, at the central computer system, market data and additional master data for the securities from a plurality of sources;
generating, for each security, at the central computer system, a single data set comprising a single value for each parameter of the market data and the master data, wherein the single data set is automatically generated after receiving data from each of the plurality of sources;
determining, for each security, at the central computer system, a lending value based on its single data set, wherein the lending value is determined automatically after the single data set is generated; and
transferring the lending value of each security from the central computer system to computers of the plurality of subsidiaries.

25. The method of claim 24, further comprising automatically determining, based on the lending values of the securities, if a total lending value of a portfolio of a credit user falls below a predetermined value.

26. The method of claim 24, wherein generating a single data set comprises:
receiving competing data from the plurality of sources;
prioritizing the competing data; and
using the competing data of the highest priority in the single data set and excluding the remaining competing data.

27. The method of claim 24, wherein determining the lending value comprises assigning a lending value of zero if the single data set satisfies an exclusion criterion.
